(19) United States
(12) Patent Application Publication
(10) Pub. No.: US 2017/0130690 A1
(43) Pub. Date: May 11, 2017

(54) BARGE ELECTRICAL GENERATION SYSTEM

(71) Applicant: Edward Lilly, Sandyville, WV (US)

(72) Inventor: Edward Lilly, Sandyville, WV (US)

(21) Appl. No.: 14/938,281

(22) Filed: Nov. 11, 2015

(51) Int. Cl. F03B 13/00; F03B 17/06; B63B 35/44

(52) U.S. Cl. CPC F03B 13/00; B63B 35/44; F03B 17/063; B63B 2035/4466

(57) ABSTRACT

A barge supported electrical generation system that includes: a barge with a catamaran style hull; pontoons on each side of the barge; articulating mounts supporting each pontoon; and a generator, which is connected to a series of pulleys. An opening is provided within the hull of the barge with a mechanism to turn the generator positioned in the opening, where the mechanism contacts water flow below the hull. The mechanism may include a paddle wheel system in one embodiment where a paddle wheel is mounted on a barrel shaft within the opening connected to the series of pulleys. In an alternative embodiment, the mechanism includes an Archimedes screw drive system. The Archimedes screw drive system preferably includes two Archimedes screw drives mounted within the opening connected to the series of pulleys.

### BACKGROUND OF THE INVENTION

Field of Invention

The present invention relates to a barge system used to generate electricity.

Description of Related Art

The generation of electrical energy electricity is usually conducted through the use of a turbine that is powered by various power sources such as petroleum, coal or in certain instances nuclear power. Many large turbines are used to generate electricity for uses in various sectors of the electrical power grid. One drawback to the traditional means for electrical generators is the pollution that is associated with the electrical generator. Typically coal or petroleum is burned to provide the power to turn the large turbines in order to generate electricity. Another means to generate electricity is the use of water power. This form of hydropower is conventionally done through the use of the dams along a river. In addition to dams one alternative of hydropower is to use electrical generators integrated with a barge that may be placed on a river. River currents provide a convenient steady flow of power that may be harnessed to turn turbines in order to generate electricity. As such further development of this suitable and environment friendly means of electrical power generation is welcome technology.

### SUMMARY OF THE INVENTION

The present invention relates to a barge supported electrical generation system according to the present invention comprising: a barge, where the barge includes a catamaran style hull; pontoons on each side of the barge; articulating mounts supporting each pontoon; a generator, where the generator is connected to a series of pulleys; an opening within the hull of the barge; and a means to turn the generator positioned in the opening, where the means to turn the generator contacts water flow below the hull. The means to turn includes a paddle wheel system in one particular embodiment where a paddle wheel is mounted on a barrel shaft within the opening connected to the series of pulleys. In an alternative embodiment, the means to turn includes an Archimedes screw drive system. The Archimedes screw drive system preferably includes two Archimedes screw drives mounted within the opening connected to the series of pulleys.

### BRIEF DESCRIPTION OF DRAWINGS

FIG. 1 depicts a sectional view of a pulley and drive system for a pontoon-based electrical generator.

FIG. 2 provides a top and sectional view of the electrical generator in accordance with the present invention.

FIG. 3 depicts an overview of positioning of the generator system according to present invention on a river.

### DETAILED DESCRIPTION

The present invention relates to an electrical generation system that uses water flow through a river in the form of a generator placed on a floating barge. The generator relies on water flowing through the barge that rotates paddles connected through Archimedes screws placed within the hull of the barge. The present invention uses a barge that includes a catamaran-style hull with pontoons on each side of the barge. Within the center of the barge are rotating drives that rotate a pulley and drive system, which drive a generator attached to the pulley. This configuration creates an electrical generator that may be used as a ready source of electricity. The barge may be a conventional barge that has been reconfigured in a form to accommodate the rotating drives, a pulleys and generators within the system to create an electrical generation system.

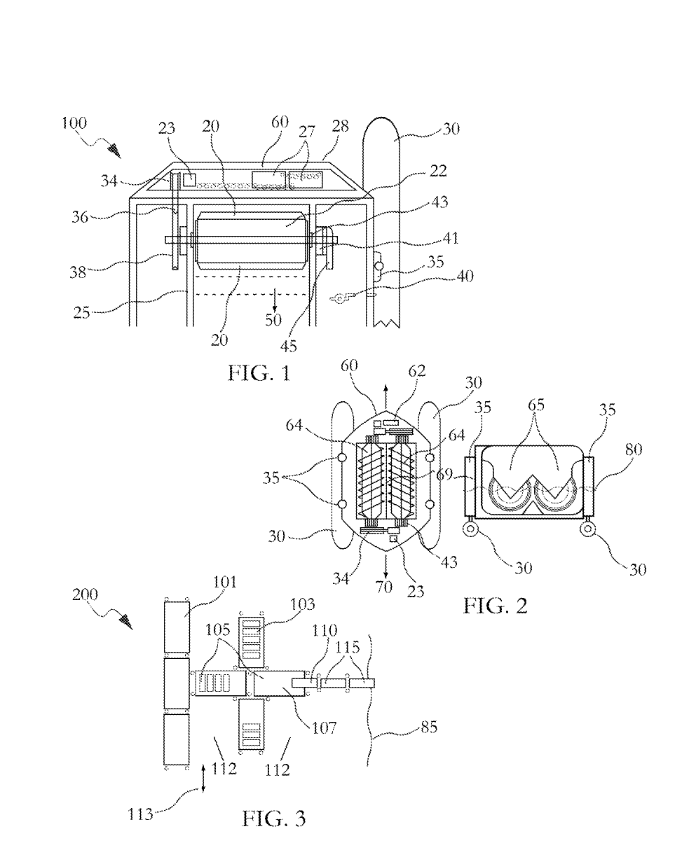

In reference to FIG. 1, a sectional view of a barge generator system (100) according to present invention as depicted. The barge includes pontoons (30) that extend the length of the barge. The pontoons (30) include articulating mounts (35) that enable the buoyancy of barge and flow of water through the opening of the barge as shown in FIG. 1. Water flows (50) at the open bottom of the barge to allow for the rotation of paddles (20). Paddles (20) are mounted on a barrel shaft (22) and the barrel shaft (22) is mounted between bearings (41), which include waterproof packing (43) as shown. A chain (45) is shown that rotates with the movement of the paddles (20) based upon the water flow provided (50) under the barge. Further connected to the barrel shaft (22) is a pulley (38) that connects to a belt (36) providing rotation of a top pulley (34). This pulley (34) connects to a generator (23) within a waterproof compartment (28). Electrical power generated by the generator (23) may be stored in batteries shown (27) and therefore providing stored energy for later consumption. The entire system is configured on a reconfigured barge (60) where the barge (60) is reconfigured to accommodate a plurality of paddles (20) within the opening of the barge (60).

A top view of the power system is shown in FIG. 2. In this top view both pontoons (30) are shown on each side of the barge (60). Further generator (62) is also shown which again is connected to the rotating drives (64). These rotating drives (64) produce a further alternative for electrical power generation. A second generator (23) is shown on the opposite end of the rotating drives (64). A centrical drive pulley (34) is shown connected to the generator (23). Again bearings provided on both drives (64) is shown and bearings (43) are water-tight packed bearings. A pair of articulating devices (35) is provided for each pontoon (30) to provide buoyancy to the barge (60). Arrow (70) relates to anchors that are placed to anchor the barge (60) in a stationary position. A sectional view is adjacent to this top view showing a catamaran hull (65) of the barge (60). This hull (65) has an opening to allow for water to flow as shown by waterline (80) over and through the drives provided within the opening of the barge (60).

The barge may be attached and anchored to a boat slip (200) as shown in FIG. 3. FIG. 3 shows an exemplary anchoring system for the electrical generator according to present invention. In this anchoring system boat slips are available connecting the barge to pilings (101). A paddlewheel Type 1 generator (103) is shown attached to the boat slip configuration. Further Archimedes screw-type generator (105) is also shown. The water flow is depicted by the arrow (113). This water flow turns the paddlewheel style (103) and also the Archimedes screw style (105) generators in accordance with the present invention. As a result multiple barges according to the present invention may be installed or placed upon this boat slip therefore providing multiple barges for electrical power generation. Typical floating sections (107) may be replaced with the electrical generator system in accordance with either style of electrical generator of the present invention.

Ramps (115) are also shown in FIG. 3 connected to a roller ramp (110) to allow access to the generators for maintenance purposes. As a result the present invention contemplates two types of electrical generating systems one involving a paddlewheel style as depicted in FIG. 1 and a second embodiment using Archimedes screw drives as shown in FIG. 2. Either system may be placed on pontoon-configured barges within a boat slip area to allow for the convenient generation of electricity based solely on water flow provided by a river. The instant invention has been shown and described in what it considers to be the most practical and preferred embodiments. It is recognized, however, that departures may be made there from within the scope of the invention and that obvious modifications will occur to a person skilled in the art.

1. A barge supported electrical generation system according to the present invention comprising:
a. a barge, where the barge includes a catamaran style hull;
b. pontoons on each side of the barge;
c. articulating mounts supporting each pontoon;
d. a generator, where the generator is connected to a series of pulleys;
e. an opening within the hull of the barge; and
f. an Archimedes screw drive system, where the Archimedes screw drive system turns the generator positioned in the opening and contacts water flow below the hull.

2. (canceled)

3. (canceled)

4. (canceled)

5. The barge supported electrical generation system according to claim 1, where the Archimedes screw drive system includes two Archimedes screw drives mounted within the opening connected to the series of pulleys.

6. The barge supported electrical generation system according to claim 1, further comprising a battery, where the battery stores electricity generated by the generator.

7. An anchoring system for a plurality of electrical generators comprising:
a. a pair of paddlewheel generators, wherein the paddlewheel generators are mounted on barges;
b. a pair of Archimedes screw-type generators, wherein the Archimedes screw-type generators are mounted on barges; and
c. a roller ramp, where the roller ramp provides access to the generators.
